(19) United States
(12) Patent Application Publication
(10) Pub. No.: US 2024/0091958 A1
(43) Pub. Date: Mar. 21, 2024

(54) HAND MECHANISM

(71) Applicant: THK CO., LTD., Tokyo (JP)

(72) Inventors: Yoshimasa Endo, Minato-ku, Tokyo (JP); Toshiya Watanabe, Minato-ku, Tokyo (JP); Min Bao, Minato-ku, Tokyo (JP)

(73) Assignee: THK CO., LTD., Tokyo (JP)

(21) Appl. No.: 18/275,307

(22) PCT Filed: Jan. 21, 2022
(86) PCT No.: PCT/JP2022/002245

§ 371 Date: Aug. 1, 2023

(30) Foreign Application Priority Data
Feb. 3, 2021 (JP) 2021-015640

(51) Int. Cl. B25J 15/00; B25J 15/06

(52) U.S. Cl. CPC B25J 15/0009; B25J 15/0625; B25J 15/0666; B25J 15/0683; B25J 5/007

(57) ABSTRACT

A hand mechanism (2) comprises a plurality of finger units. Each of the plurality finger units is equipped with a first finger link unit (211) including a fingertip, a first joint unit (22) provided at an end portion on a finger base side of the first finger link unit (211), a second finger link unit (212) connected to the first finger link unit (211) via the first joint unit (22), and a second joint unit (23) provided at an end portion on a finger base side of the second finger link unit (212). A suction mechanism (600) is provided on at least one predetermined finger unit of the plurality of finger units (21). The suction mechanism (600) is provided on a dorsal surface (216) of the first finger link unit (211) in a predetermined finger, and suctions and retains a target object by generating negative pressure.

### TECHNICAL FIELD

The present invention relates to a technology that picks up a target object by a plurality of finger units.

### BACKGROUND ART

Conventionally, there has been known a hand mechanism mounted on a robot arm or the like and configured to grasp a target object by a plurality of finger units. Further, a hand mechanism in which a suction mechanism for suctioning a target object is combined with a hand mechanism is also known. For example, Patent document 1 and Patent document 2 each discloses the configuration in which a suction rod is provided at a base unit that supports a plurality of finger units to be able to advance and retract. Patent document 3 discloses the configuration in which a suction cup is mounted on a ventral portion of each of finger units. Patent document 4 discloses the configuration in which a suction cup of a suction mechanism is mounted on a part on a finger base side from a first joint in each of finger units.

### CITATION LIST

### Patent Document

Patent document 1: Japanese Patent Laid-Open No. 2019-209458
Patent document 2: Japanese Patent Laid-Open No. 2020-006490
Patent document 3: Japanese Patent No. 5525587
Patent document 4: Japanese Patent No. 6215029

### SUMMARY OF THE INVENTION

### Technical Problem

In the above-described conventional technology, there are cases where the way of placement of the target object and the like are restricted. For example, in each of the configurations of Patent documents 1, 2 and 4, it may be difficult to cause the suction mechanism to approach a position suitable for suction of the target object, when the target object is stored in a storage box with a narrow frontage, when there is a wall above the target object, or when the target object is placed at a corner portion of the storage box. Further, in the configuration of Patent document 3, in the case of grasping a target object with a small thickness, or the like, only a part of the suction cup is likely to be sandwiched between the target object and the finger unit, and it may be difficult to grasp the target object in a stable posture.

An object of the present invention is to provide a technology capable of favorably achieving both grasp of a target object and suction of the target object.

### Solution to Problem

The present invention is a hand mechanism which comprises a plurality of finger units equipped with a first finger link unit including a fingertip, a first joint unit provided at an end portion on a finger base side of the first finger link unit, a second finger link unit connected to the first finger link unit via the first joint unit, and a second joint unit provided at an end portion on a finger base side of the second finger link unit. The hand mechanism includes a suction mechanism provided on a dorsal surface of the first finger link unit in at least one predetermined finger unit of the plurality of finger units, and configured to suction and retain a target object by generating negative pressure.

### Advantageous Effects of Invention

According to the present invention, it is possible to provide the technology capable of favorably achieving both grasp of a target object and suction of the target object.

### BRIEF DESCRIPTION OF DRAWINGS

FIG. 1 is a view illustrating a schematic configuration of a robot arm according to an embodiment.

FIG. 2 is a perspective view of a hand mechanism according to the embodiment.

FIG. 3 is a top view of the hand mechanism according to the embodiment.

FIG. 4 is a side view of a finger unit of the hand mechanism according to the embodiment.

FIG. 5 is a view of a tip end portion side of the finger unit of the hand mechanism according to the embodiment seen from a direction of an arrow A in FIG. 4.

FIG. 6 is a view illustrating a movable range of a second joint unit in the finger unit of the hand mechanism according to the embodiment.

FIG. 7 is a view illustrating a movable range of a first joint unit in the finger unit of the hand mechanism according to the embodiment.

FIG. 8 is a first view illustrating a configuration example of a suction mechanism according to the embodiment.

FIG. 9 is a second view illustrating the configuration example of the suction mechanism according to the embodiment.

FIG. 10 is a first view illustrating a positional relationship of the suction mechanism and a first finger link unit.

FIG. 11 is a second view illustrating the positional relationship of the suction mechanism and the first finger link unit.

FIG. 12 is a view for explaining a basic operation example of the hand mechanism in a case of suctioning a target object.

FIG. 13 is a view for explaining a basic operation example of the hand mechanism in a case of grasping the target object.

FIG. 14A is a first view for explaining an operation example of the hand mechanism in a case of picking up a target object from a storage box in which an ejection port is provided in a side surface.

FIG. 14B is a second view for explaining an operation example of the hand mechanism in a case of picking up the target object from the storage box in which the ejection port is provided in the side surface.

FIG. 15 is a view for explaining an operation example of the hand mechanism in a case of picking up a target object placed against a wall in the storage box.

FIG. 16A is a first view for explaining an operation example of the hand mechanism in a case of picking up a target object placed at a corner portion in the storage box.

FIG. 16B is a second view for explaining an operation example of the hand mechanism in a case of picking up the target object placed at the corner portion in the storage box.

FIG. 17A is a first view for explaining an operation example of the hand mechanism in a case of picking up the target object stored in the storage box in a diagonally tilted state.

FIG. 17B is a second view for explaining an operation example of the hand mechanism in the case of picking up the target object stored in the storage box in the diagonally tilted state.

FIG. 17C is a third view for explaining an operation example of the hand mechanism in the case of picking up the target object stored in the storage box in the diagonally tilted state.

FIG. 18 is a view for explaining an operation example of the hand mechanism in a case of picking up a spherical target object.

FIG. 19 is a view for explaining an operation example of the hand mechanism in a case of simultaneously picking up two target objects.

FIG. 20 is a view illustrating another configuration example of the hand mechanism.

### DESCRIPTION OF EMBODIMENTS

A hand mechanism according to the present invention includes a plurality of finger units. Each of the plurality of finger units is equipped with a first finger link unit including a fingertip, a first joint unit provided at an end portion on a finger base side of the first finger link unit, a second finger link unit that is connected to the first finger link unit via the first joint unit, and a second joint unit provided at an end portion on a finger base side of the second finger link unit. In other words, each of the plurality of finger units has at least two joint portions. Thereby, it is possible to flexibly change a form of each of the finger units in response to a situation where a target object is placed, a shape of the target object, or the like. For example, when the hand mechanism is caused to approach a suitable position for grasping the target object, it becomes easy to change the form of each of the finger units so that each of the finger units does not interfere with objects or the like existing around the target object. Further, it also becomes easy to change the form of each of the finger units according to the shape, size or the like of the target object.

Incidentally, in a field where target objects suitable for being picked up by grasping, and target objects suitable for being picked up by suction coexist, a mechanism that can both grasp and suction is desired. Concerning this, a method of juxtaposing the suction mechanism with the hand mechanism is conceivable. However, when the hand mechanism is caused to approach the suitable position for grasping or suction of the target object, it may become difficult to change the form of the finger units so as not to interfere with the objects or the like existing around the target object, or control at that time may be complicated. Further, it may also be difficult to grasp or suction the target object in a stable posture because the suction mechanism interferes with surrounding objects or the target object when grasping the target object, or the finger units interfere with the surrounding objects or the target object when suctioning the target object.

Thus, in the hand mechanism according to the present invention, among the plurality of finger units, in at least one finger unit (predetermined finger unit), a suction mechanism is provided on a dorsal surface of the first finger link unit. In other words, the suction mechanism is provided on the dorsal surface of a fingertip in the predetermined finger unit. The suction mechanism is a mechanism that suctions and retains a target object by generating negative pressure. Here, when the target object is grasped by the plurality of finger units including the predetermined finger unit, it is possible to grasp the target object by bringing a ventral surface of the first finger link unit in the predetermined finger unit into contact with the target object. Thereby, it becomes possible to grasp the target object without allowing the suction mechanism to interfere with the target object. Further, it is also possible to grasp the target object by using the finger units other than the predetermined finger unit. Therefore, it becomes possible to grasp the target object in a stable posture.

Further, the plurality of finger units according to the present invention has at least two joint units, and therefore when the hand mechanism is caused to approach the suitable position for grasping or suction of a target object, it is also easy to change the form of the plurality of finger units so that the suction mechanisms or the finger units do not interfere with the objects or the like existing around the target object. For example, when a target object is stored in a storage box with a narrow frontage, it is possible to cause the suction mechanism to approach the suitable position for suction of the target object by making the predetermined finger unit have a substantially linear form and inserting the predetermined finger unit inside the storage box. At this time, the finger units other than the predetermined finger unit can be configured to have a form that can be inserted into the storage box without interfering with a wall or the like of the storage box, or can be configured to have a form that is not inserted into the storage box without interfering with the wall or the like of the storage box. Thereby, it is possible to suction the target object stored in the storage box with a narrow frontage, in a stable posture. Further, when a target object is placed at a corner portion of the storage box, it is possible to cause the suction mechanism to approach the suitable position for suction of the target object by making the predetermined finger unit to have a substantially cranked form, for example. Thereby, it is possible to suction the target object placed at the corner portion of the storage box, in a stable posture.

Consequently, according to the hand mechanism according to the present invention, it is possible to favorably achieve both grasp of the target object and suction of the target object.

The suction mechanism according to the present invention may be configured by including a suction nozzle that extends from the finger base side to the fingertip side of the first finger link unit in the predetermined finger unit, and a pad mounted on a tip end of the suction nozzle and formed to be contractible toward the finger base side from the fingertip side of the first finger link unit. At this time, the suction mechanism may be mounted on the first finger link unit so that a position of the tip end of the suction nozzle is positioned on the finger base side from an end portion on the fingertip side of the first finger link unit, in an axial direction of the first finger link unit.

Here, when the target object is grasped by a plurality of finger units including the predetermined finger unit, the pad is likely to interfere with a floor or the like where the target object is placed, on the way to cause the predetermined finger unit to approach the suitable position for grasping of the target object. Concerning this, if the pad is formed to be contractible toward the finger base side from the fingertip side of the first finger link unit, the above-described approach can be properly continued by contracting the pad even if the pad interferes with the floor or the like on the way of the above-described approach. Further, the position of the tip end of the suction nozzle is retracted in a finger base direction from the end portion on the fingertip side of the first finger link unit, and therefore the tip end of the suction nozzle is restrained from interfering with the floor or the like on the way of the approach described above. Thereby, even when the target object is grasped by the plurality of finger units including the predetermined finger unit, it is possible to cause the predetermined finger unit to approach the suitable position for gasping of the target object.

Note that the above-described suction mechanism may be mounted on the first finger link unit so that a position of a tip end surface of the pad in an axial direction of the first finger link unit is in a position protruding in a fingertip direction from the end portion on the fingertip side of the first finger link unit when the above-described pad is in an uncontracted state. Thereby, when the target object is suctioned by the suction mechanism, the tip end surface of the pad can be brought into contact with the target object before the tip end of the first finger link unit. In other words, it is possible to restrain the fingertip portion (the end portion on the fingertip side in the first finger link unit) of the predetermined finger unit from interfering with the target object when the suction mechanism is caused to approach the suitable position for suction of the target object. As a result, it is possible to suction the target object in a more reliably stable posture.

Here, the pad may be formed so that the position of the tip end surface of the pad in the axial direction of the first finger link unit contracts to a position equivalent to the end portion on the fingertip side of the first finger link unit, when an external force different from an external force at a time of suction of the target object is applied on the pad, in the case where the suction mechanism is mounted on the first finger link unit so that the position of the tip end surface of the pad in the axial direction of the first finger link unit is the protruding position in the fingertip direction from the end portion on the fingertip side of the first finger link unit when the pad is in the uncontracted state. Thereby, in a case where the target object is grasped by the plurality of finger units including the predetermined finger unit, on the way of causing the predetermined finger unit to approach the suitable position for grasping of the target object, the pad is restrained from inhibiting the approach.

Here, the hand mechanism according to the present invention may be configured to be switchable between a first mode for suctioning and picking up the target object by the suction mechanism of the predetermined finger unit, and a second mode of grasping and picking up the target object by at least two finger units among the plurality of finger units. Thereby, even in the field where target objects suitable for being picked up by grasping and target objects suitable for being picked up by suction coexist, it is possible to efficiently pick up these target objects.

Note that in the above-described first mode, the predetermined finger unit functions as a suction finger unit for bringing the pad of the suction mechanism into contact with a target object and thereafter suctioning the target object, and at least one finger unit among the finger units other than the predetermined finger unit may function as a retaining finger unit for retaining a posture of the target object suctioned by the predetermined finger unit. Thereby, the posture of the target object suctioned by the suction mechanism can be stabilized. As a result, the posture of the target object is restrained from becoming unstable, in a step of lifting up the target object, a step of moving the lifted target object to a predetermined placement position and the like.

### Embodiment

Hereinafter, a specific embodiment of the present invention will be described based on the drawings. Dimensions, materials, shapes, relative dispositions and the like of components described in the present embodiment are not intended to limit the technical scope of the invention to only these dimensions, materials, shapes, relative dispositions and the like unless otherwise specified.

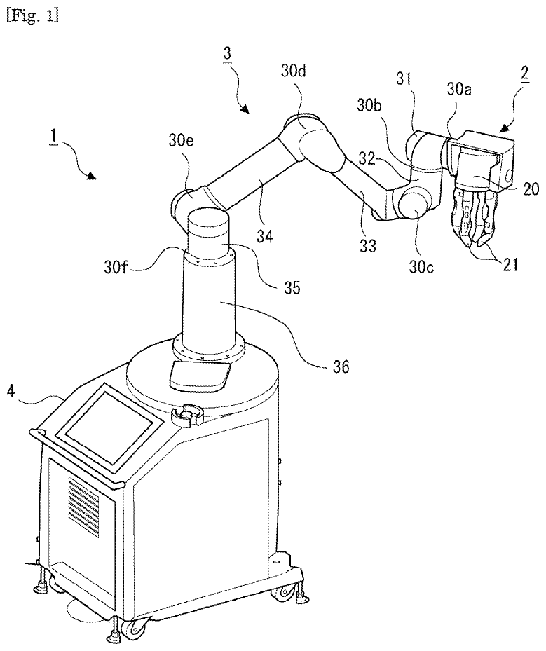

Here, a case where the hand mechanism according to the present invention is applied to a robot arm will be described. FIG. 1 is a view illustrating a schematic configuration of the robot arm according to the present embodiment. A robot arm 1 includes a hand mechanism 2, an arm mechanism 3, and a base seat unit 4. The hand mechanism 2 is mounted on one end of the arm mechanism 3. Further, the other end of the arm mechanism 3 is mounted on the base seat unit 4. The hand mechanism 2 includes a base unit 20 connected to the arm mechanism 3, and a plurality of finger units 21 (four finger units 21 in an example illustrated in FIG. 1) that are movably supported by the base unit 20. Note that a detailed configuration of the hand mechanism 2 will be described later.

(Arm Mechanism)

The arm mechanism 3 includes a first arm link unit 31, a second arm link unit 32, a third arm link unit 33, a fourth arm link unit 34, a fifth arm link unit 35, and a connection member 36. A base unit 20 of the hand mechanism 2 is connected to a first joint unit 30a formed on one end side of the first arm link unit 31 of the arm mechanism 3. A motor (not illustrated) for rotating the hand mechanism 2 around an axis of the first arm link unit 31 with respect to the first arm link unit 31 is provided at the first joint unit 30a. The other end side of the first arm link unit 31 is connected to one end side of the second arm link unit 32 at a second joint unit 30b. The first arm link unit 31 and the second arm link unit 32 are connected so that central axes thereof intersect each other perpendicularly. In the second joint unit 30b, a motor (not illustrated) for rotating the first arm link unit 31 around an axis of the second arm link unit 32 with the other end side thereof as a center with respect to the second arm link unit 32 is provided. Further, the other end side of the second arm link unit 32 is connected to one end side of the third arm link unit 33 at a third joint unit 30c. In the third joint unit 30c, a motor (not illustrated) for relatively rotating the second arm link unit 32 with respect to the third arm link unit 33 is provided.

Likewise, the other end side of the third arm link unit 33 is connected to one end side of the fourth arm link unit 34 at a fourth joint unit 30d. Further, the other end side of the fourth arm link unit 34 is connected to the fifth arm link unit 35 at a fifth joint unit 30e. In the fourth joint unit 30d, a motor (not illustrated) for relatively rotating the third arm link unit 33 with respect to the fourth arm link unit 34 is provided. Further, at the fifth joint unit 30e, a motor (not illustrated) for relatively rotating the fourth arm link unit 34 with respect to the fifth arm link unit 35 is provided. Further, the fifth arm link unit 35 is connected to the connection member 36 disposed perpendicularly from the base seat unit 4, at a sixth joint unit 30f. The fifth arm link unit 35 and the connection member 36 are connected so that respective central axes are coaxial with each other. At the sixth joint unit 30f, a motor (not illustrated) for rotating the fifth arm link unit 35 around axes of the fifth arm link unit 35 and the connection member 36 is provided. According to the configuration like this, for example, the arm mechanism 3 can be made a mechanism having six degrees of freedom.

(Hand Mechanism)

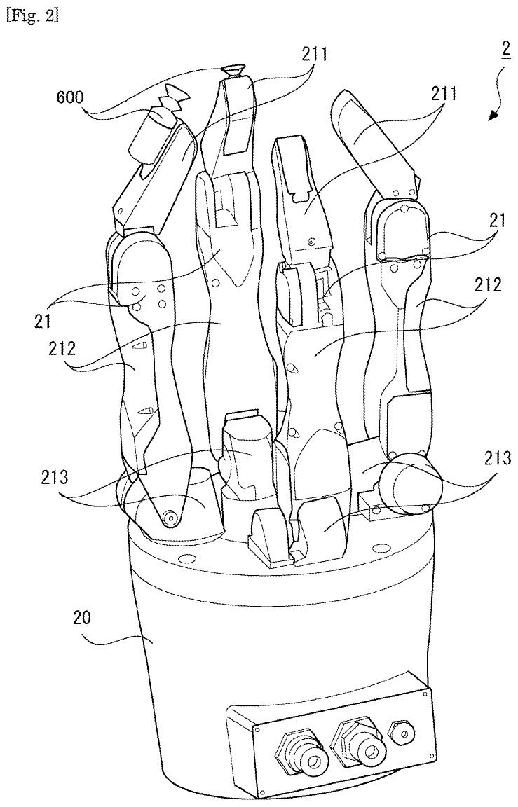

Next, a configuration of the hand mechanism 2 will be described based on FIG. 2 to FIG. 11. The hand mechanism 2 in the present example is configured to be switchable between a mode (first mode) of grasping and picking up a target object such as a workpiece, and a mode (second mode) of suctioning and picking up the target object.

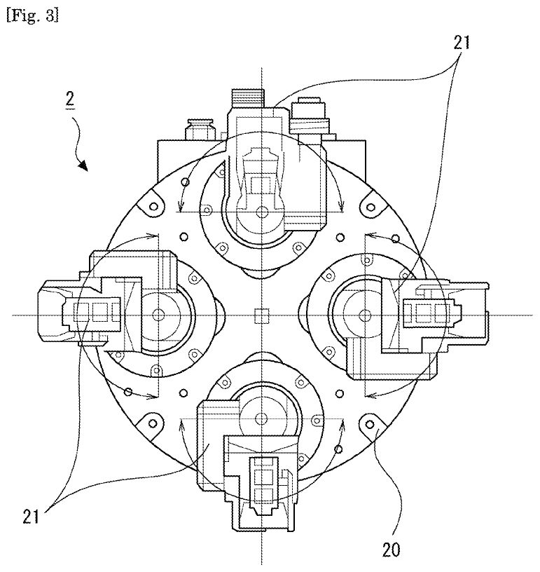

FIG. 2 is a perspective view of the hand mechanism 2. FIG. 3 is a top view of the hand mechanism 2. Note that arrows in FIG. 3 indicate rotational movable ranges of the respective finger units 21. As illustrated in FIG. 2 and FIG. 3, in the hand mechanism 2, the four finger units 21 are disposed at equal angular intervals (that is, 90-degree intervals) on a circumference with an axis in a longitudinal direction (perpendicular direction to a paper surface in FIG. 3) of the hand mechanism 2 as a center in the base unit 20. In the present example, among the four finger units 21, in two finger units 21 (predetermined finger units), suction mechanisms 600 are provided. Note that other structures than the suction mechanism 600 are common in all the four finger units 21. However, operations of the four finger units 21 are respectively controlled independently.

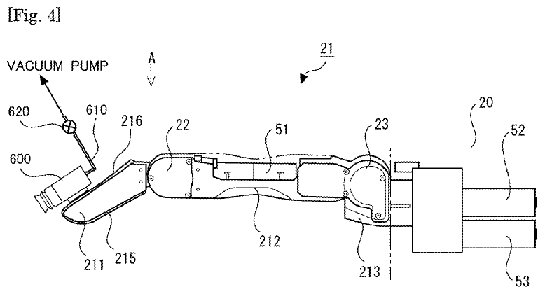

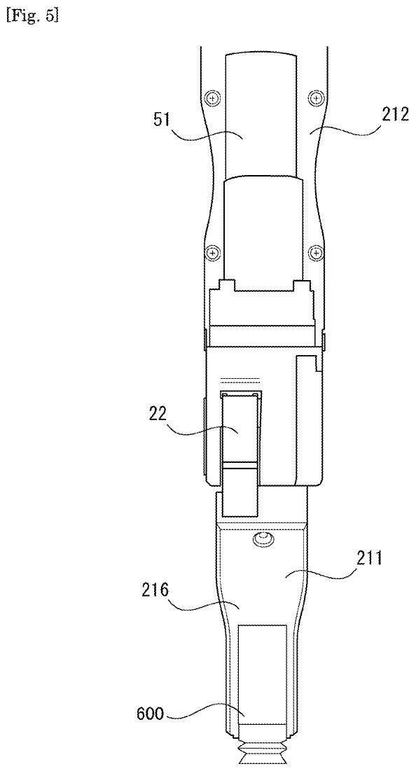

FIG. 4 to FIG. 7 are views for explaining a configuration of the finger unit 21. FIG. 4 to FIG. 7 illustrate a configuration of the predetermined finger unit 21 among the four finger units 21. FIG. 4 is a side view of the predetermined finger unit 21. Note that in FIG. 4, the base unit 20 is illustrated in a transparent state. Further, FIG. 5 is a view of a tip end portion side of the finger unit 21 seen from a direction of an arrow A in FIG. 4. Further, in FIG. 4 and FIG. 5, a part of a second finger link unit 212 of the finger unit 21 described later is illustrated in a transparent state, and an internal structure of the second finger link unit 212 is also illustrated.

As illustrated in FIG. 2 and FIG. 4, each of the finger units 21 has a first finger link unit 211, the second finger link unit 212, and a base end unit 213. Between the first finger link unit 211 and the second finger link unit 212, a first joint unit 22 formed to be able to flex and extend is provided. Between the second finger link unit 212 and the base end unit 213, a second joint unit 23 formed to be able to flex and extend is provided. The base end unit 213 of the finger unit 21 is connected to the base unit 20 in a state of being rotatable around an axis in a longitudinal direction (perpendicular direction to a paper surface in FIG. 3) of the finger unit 21.

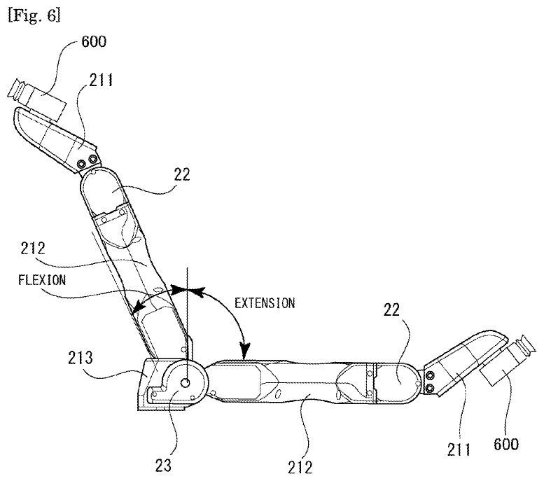

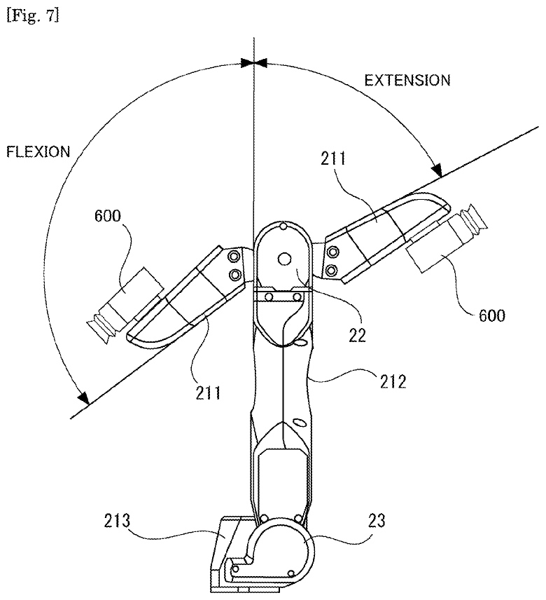

As illustrated in FIG. 4, a second motor 52 and a third motor 53 are contained in the base unit 20. As illustrated in FIG. 6, the second motor 52 is a motor for flexing and extending the second joint unit 23. The third motor 53 is a motor for rotationally driving the entire finger unit 21 in a range indicated by an arrow in FIG. 3. Further, in the second finger link unit 212, a first motor 51 is contained as illustrated in FIG. 5. As illustrated in FIG. 7, the first motor 51 is a motor for flexing and extending the first joint unit 22.

The structure described so far is not peculiar to the predetermined finger unit 21 but is common to the four finger units 21.

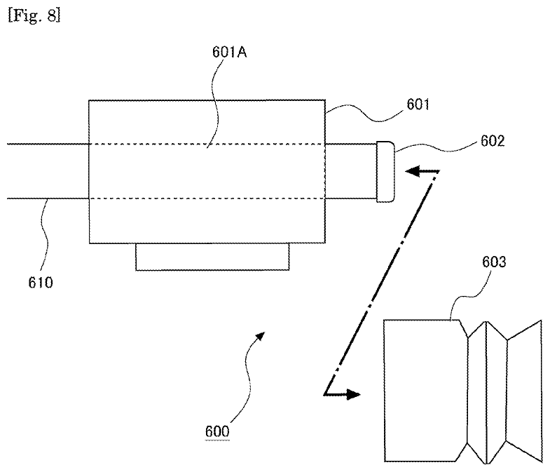

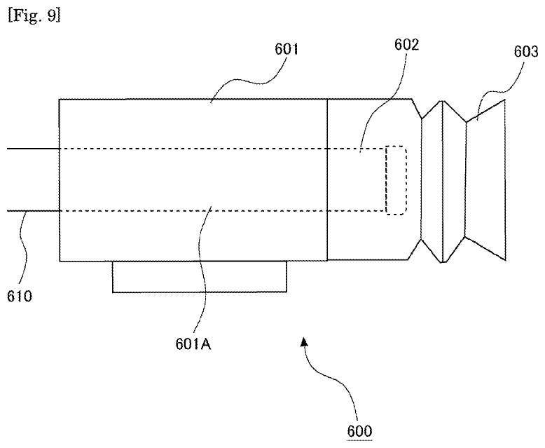

Next, FIG. 8 to FIG. 11 are views for explaining a configuration of the suction mechanism 600 provided at the predetermined finger unit 21. FIG. 8 and FIG. 9 are side views of the suction mechanism 600. Note that in FIG. 8, a nozzle body 601 described later is illustrated in a transparent state. Further, in FIG. 9, a pad 603 described later is also illustrated in a transparent state in addition to the nozzle body 601.

As illustrated in FIG. 4, the suction mechanism 600 is mounted on a dorsal surface (dorsal surface 216 of the first finger link unit 211) of a fingertip in the predetermined finger unit 21. Thereby, it is possible to grasp a target object by using a ventral surface (ventral surface 215 of the first finger link unit 211) of the fingertip in the predetermined finger unit 21 when grasping the target object by the plurality of finger units 21 including the predetermine finger unit 21. The suction mechanism 600 is a mechanism for suctioning a target object by using negative pressure. As illustrated in FIG. 8 and FIG. 9, the suction mechanism 600 like this is configured by including a nozzle body 601, a suction nozzle 602, and a pad 603. The nozzle body 601 is a casing in which a negative pressure passage 601A is formed and is mounted on the dorsal surface 216 of the first finger link unit 211. The suction nozzle 602 is a cylindrical nozzle projectingly provided at the nozzle body 601, and an inside of the suction nozzle 602 communicates with the negative pressure passage 601A. The suction nozzle 602 in the present example is formed to extend toward the fingertip side from the finger base side along an axial direction of the first finger link unit 211. The suction nozzle 602 may be integrally molded with the nozzle body 601 or may be fixed to the nozzle body 601 by a screw mechanism or the like. Further, the pad 603 is put on the suction nozzle 602. The pad 603 is a cylindrical body formed into a bellows shape and is produced of a material having flexibility such as a silicon rubber. Thereby, it is possible to bring a tip end surface of the pad 603 into close contact with the target object when suctioning the target object by the suction mechanism 600. The pad 603 like this is mountable to and dismountable from the suction nozzle 602 as illustrated in FIG. 8.

The suction mechanism 600 configured as described above is connected to a vacuum pump via a vacuum pipe 610, as illustrated in FIG. 4. In detail, the negative pressure passage 601A of the nozzle body 601 is connected to the vacuum pump via the vacuum pipe 610. The vacuum pump is a pump for suctioning gas. The vacuum pump may be provided separately from the robot arm 1 or may be provided at the base seat unit 4 or the like. When the vacuum pump like this is operated, air inside of the negative pressure passage 601A and the suction nozzle 602, and inside of the pad 603 can be suctioned into the vacuum pump via the vacuum pipe 610. As a result, negative pressure can be generated at a tip end of the pad 603. Thereby, it is possible to suction the target object by the tip end of the pad 603 by generating negative pressure at the tip end of the pad 603 in a state where the tip end surface of the pad 603 is in close contact with the target object. Note that an electromagnetic valve (hereinafter, may be described as “negative pressure electromagnetic valve”) 620 for continuing (opening) or shutting off (closing) an internal passage of the vacuum pipe 610 may be provided halfway through the vacuum pipe 610. Thereby, it is possible to quickly switch generation of negative pressure and cancel of the negative pressure in the tip end of the pad 603 by opening and closing the negative pressure electromagnetic valve 620 while maintaining the vacuum pump in an operated state.

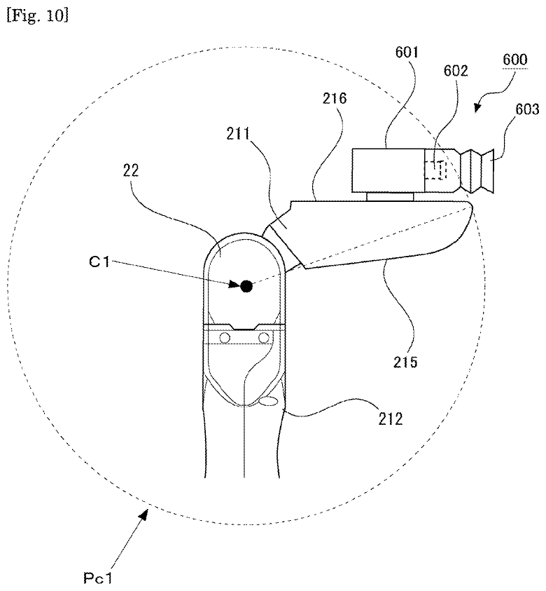

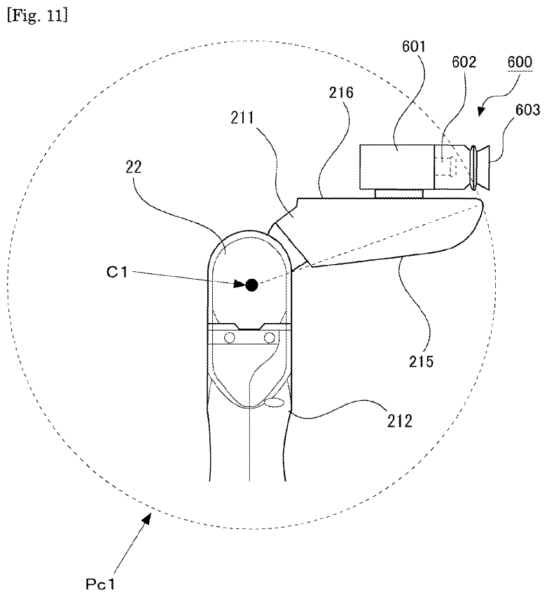

FIG. 10 and FIG. 11 are views each for explaining a positional relationship of each part of the suction mechanism 600 and the first finger link unit 211. FIG. 10 is a view illustrating a case where the pad 603 of the suction mechanism 600 is not contracted. FIG. 11 is a view illustrating a case where the pad 603 of the suction mechanism 600 is in a predetermined contracted state. The “state where the pad 603 is not contracted” mentioned here is a state where an external force does not act on the pad 603 and is a state where a length in an axial direction of the pad 603 is a free length. Further, “predetermined contracted state” mentioned here is a state where the pad 603 can contract most when suctioning and retaining the target object and is a state where a contraction degree is smaller than a state where the pad 603 is contracted to a limit corresponding to physical properties of the pad 603. Note that C1 in FIG. 10 and FIG. 11 is a center when rotating the first finger link unit 211 in a flexing direction and extending direction as illustrated in FIG. 7 mentioned above. Further, Pc1 in FIG. 10 and FIG. 11 is an imaginary circle in which C1 is a center, and a distance from C1 to the tip end (end portion on the fingertip side) of the first finger link unit 211 is a radius.

As illustrated in FIG. 10 and FIG. 11, a size and/or a mounting position to the first finger link unit 211 of each of the parts of the suction mechanism 600 in the present example are defined so that the tip end of the suction nozzle 602 is positioned inside of the circle Pc1. Thereby, a position of the tip end of the suction nozzle 602 in the axial direction of the first finger link unit 211 is a position retracted to the finger base side from the tip end of the first finger link unit 211. Further, as illustrated in FIG. 10, the size and/or the mounting position to the first finger link unit 211 of each of the parts of the suction mechanism 600 in the present example is defined so that the tip end surface of the pad 603 at a time of the pad 603 being in an uncontracted state is positioned outside of the circle Pc1. Thereby, when the pad 603 is in the uncontracted state, the position of the tip end surface of the pad 603 in the axial direction of the first finger link unit 211 is a position protruding from the tip end of the first finger link unit 211. Further, as illustrated in FIG. 11, the sizes and/or the mounting position to the first finger link unit 211 of each of the parts of the suction mechanism 600 in the present example are defined so that the tip end surface of the pad 603 at the time of the pad 603 being in the predetermined contracted state is positioned on a circumference of the circle Pc1 or outside the circle Pc1. Thereby, when the pad 603 is in the predetermined contracted state, the position of the tip end surface of the pad 603 in the axial direction of the first finger link unit 211 is in the position equivalent to the tip end of the first finger link unit 211 or the position protruding in the fingertip direction. Note that “predetermined contracted state” mentioned here is the state in which the contraction degree is smaller than the state where the pad 603 is contracted to the limit corresponding to the physical properties of the pad 603 as described above. Therefore, even when the size and/or the mounting position to the first finger link unit 211 of each of the parts of the suction mechanism 600 are defined so that the tip end surface of the pad 603 at the time of the pad 603 being in the predetermined contracted state is positioned outside the circle Pc1, when a different external force from a force at the time of suction of the target object is applied to the pad 603, the pad 603 can be contracted until the position of the tip end surface of the pad 603 becomes the position on the circumference of the circle Pc1 (position in which the position of the tip end surface of the pad 603 in the axial direction of the first finger link unit 211 is equivalent to the tip end of the first finger link unit 211).

(Base Seat Unit)

The base seat unit 4 is a base seat for supporting the arm mechanism 3. In the base seat unit 4, various control devices are contained, such as a control device for controlling the arm mechanism 3, a control device for controlling the hand mechanism 2, and a control device for controlling the suction mechanism 600. By these control devices, a motor for driving the respective joint units of the arm mechanism 3, a motor for driving the respective joint units of the hand mechanism 2, the negative pressure electromagnetic valve 620 of the hand mechanism 2, and the like are controlled. Note that the vacuum pump mentioned above may be contained in the base seat unit 4.

### Operation Effect of Present Embodiment

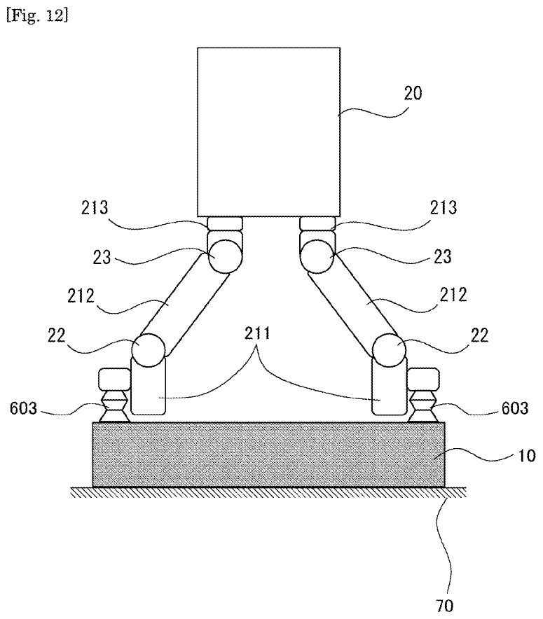

Here, an operation effect of the present embodiment will be described based on FIG. 12 to FIG. 19. FIG. 12 is a view for explaining a basic operation example of the hand mechanism 2 in a case of suctioning a target object. In the example illustrated in FIG. 12, the target object 10 having a rectangular section is placed on a bottom 70 of a storage box 80. In the case like this, the first motor 51, the second motor 52, and the third motor 53 of each of the finger units 21 are controlled first so that the tip end surface of the pad 603 in each of the two predetermined finger units 21 is parallel to a top surface of the target object 10. Next, the arm mechanism 3 is controlled so that the suction mechanism 600 lowers to the suitable position (for example, a position in which the tip end surface of the pad 603 is in close contact with the top surface of the target object 10) for suction of the target object 10. When control of these is performed, as illustrated in FIG. 12, the tip end surface of the pad 603 of the suction mechanism 600 contacts the top surface of the target object 10 before the predetermined finger unit 21. This is because the position of the tip end surface of the pad 603 in the state where the pad 603 is not contracted is in the position protruding in the fingertip direction from the tip end of the first finger link unit 211 as illustrated in FIG. 10 mentioned above. Subsequently, when the suction mechanism 600 moves to the suitable position for suction of the target object 10, the negative pressure electromagnetic valve 620 is opened. Thereby, air inside the pad 603 is suctioned by the vacuum pump through the negative pressure passage 601A in the suction nozzle 602 and the vacuum pipe 610. As a result, negative pressure is generated at the tip end of the pad 603. When the negative pressure is generated at the tip end of the pad 603, the target object 10 is suctioned to the finger base side of the first finger link unit 211, and with this, the pad 603 is contracted, but the suction operation like this is not hindered by the predetermined finger unit 21. This is because the position of the tip end surface of the pad 603 at the time of the pad 603 being in the predetermine contracted state becomes the position equivalent to the tip end of the first finger link unit 211 or the position protruding in the fingertip direction, as illustrated in FIG. 11 mentioned above. As a result, it is possible to cause the suction mechanism 600 to approach the suitable position for suction of the target object 10. Thereby, it is possible to suction and retain the target object 10 in a stable posture.

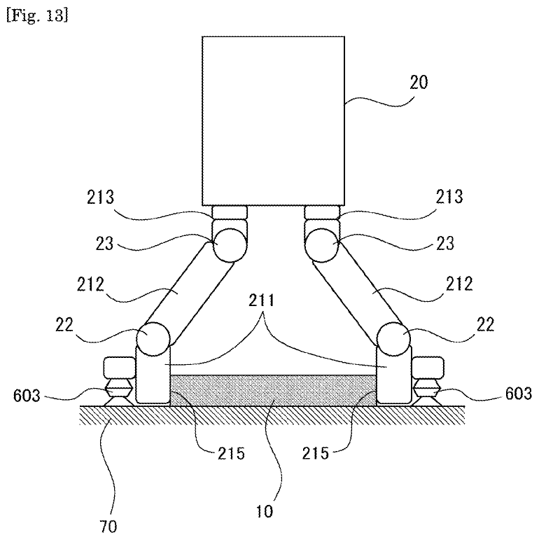

Next, a basic operation example of the hand mechanism 2 in a case of grasping a target object will be described based on FIG. 13. In the example illustrated in FIG. 13, the target object 10 having a rectangular section is placed on the bottom 70 of the storage box 80. In the case like this, the first motor 51, the second motor 52, and the third motor 53 in each of the two predetermined finger units 21 are controlled first so that a space between the ventral surfaces (ventral surfaces 215 of the first finger link units 211) in the fingertips of the two predetermined finger units 21 is wider than a width of the target object 10, and heights of the fingertips become the same. Next, the arm mechanism 3 is controlled so that the positions of the fingertips of the two predetermined finger units 21 lower to the suitable position for grasping of the target object 10. When the positions of the fingertips of the two predetermined finger units 21 lower to the suitable position for grasping of the target object 10, the first motor 51, the second motor 52, and the third motor 53 of each of the finger units 21 are controlled so that the space between the fingertips of the two predetermined finger units 21 is narrowed. When control of these is performed, as illustrated in FIG. 13, the ventral surfaces (ventral surfaces 215 of the first finger link units 211) of the fingertips in the two predetermined finger units 21 respectively contact opposing side surfaces of the target object 10. Here, the suction mechanism 600 in the present example is mounted on the dorsal surface (dorsal surface 216 of the first finger link unit 211) of the fingertip in the predetermined finger unit 21. Therefore, in the grasping operation described above, the suction mechanism 600 does not interfere with the target object 10. Note that in a case where the thickness of the target object 10 is thin or the like, the pad 603 of the suction mechanism 600 is likely to contact the bottom 70 of the storage box on the way of lowering the hand mechanism 2 to the suitable position for grasping of the target object 10. However, since the pad 603 in the present example is configured to be contractible to the position in which the position of the tip end surface of the pad 603 in the axial direction of the first finger link unit 211 is equivalent to the tip end of the first finger link unit 211, the pad 603 does not hinder the above-described lowering operation. Further, since the position of the tip end of the suction nozzle 602 is in the position retracted in the finger base direction from the tip end of the first finger link unit 211 as illustrated in FIG. 10 and FIG. 11 mentioned above, the suction nozzle 602 does not interfere with the bottom 70 of the storage box. As a result, even when the target object 10 is grasped by using the predetermined finger units 21 to which the suction mechanisms 600 are mounted, it is also possible to cause the finger units 21 to approach the suitable position for grasping of the target object 10. Accordingly, it is possible to grasp the target object 10 in a stable posture.

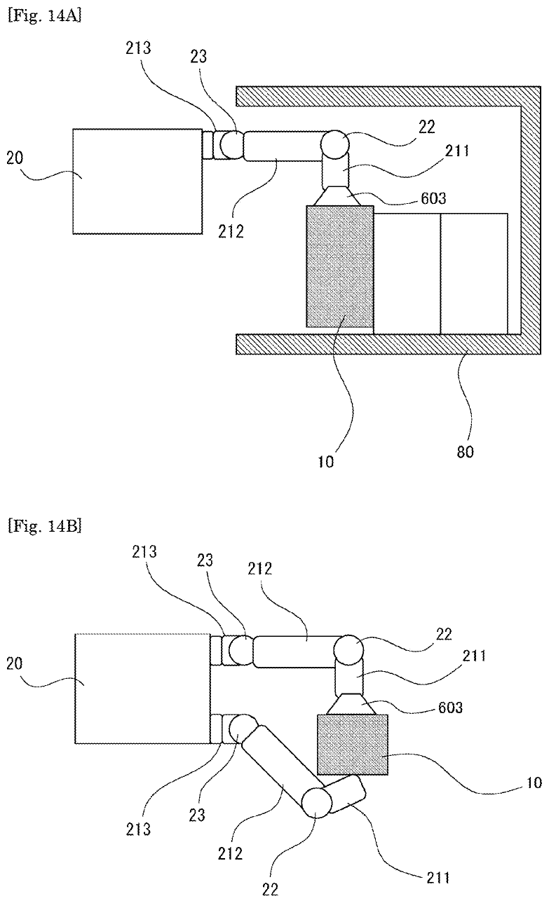

Next, an operation example of the hand mechanism 2 in a case of picking up a target object from a storage box in which an ejection port is provided in a side surface will be described based on FIG. 14A. In an example illustrated in FIG. 14A, a target object 10 is stored in a storage box 80 in which the ejection port is provided in the side surface. In the case like this, the arm mechanism 3 is controlled first so that the base unit 20 is turned laterally (horizontally). Further, the first motor 51, the second motor 52, and the third motor 53 of a predetermined finger unit 21 are controlled so that the second finger link unit 212 is horizontal, and the first finger link unit 211 faces downward in the vertical direction. In other words, the first motor 51, the second motor 52, and the third motor are controlled so that the predetermined finger unit 21 is in a substantially L-shaped form. Subsequently, the arm mechanism 3 is controlled to move the hand mechanism 2 horizontally. Thereby, the fingertip of the predetermined finger unit 21 is inserted into the storage box 80, and the tip end surface of the pad 603 is moved to above the target object 10. After the tip end surface of the pad 603 is moved to above the target object 10, the arm mechanism 3 is controlled so that the hand mechanism 2 lowers along the vertical direction. When control of these is performed, the suction mechanism 600 is moved to a suitable position for suction of the target object 10 (position at which the tip end surface of the pad 603 is in close contact with a top surface of the target object 10) as illustrated in FIG. 14A. When the tip end surface of the pad 603 moves to the position at which the tip end surface of the pad 603 is in close contact with the top surface of the target object 10, the negative pressure electromagnetic valve 620 is opened. Thereby, the target object 10 can be suctioned by the suction mechanism 600. Thereafter, the arm mechanism 3 is controlled so that the hand mechanism 2 rises, and subsequently, the arm mechanism 3 is controlled so that the hand mechanism 2 moves horizontally toward an opposite direction from the above, whereby the target object 10 is taken out from the storage box 80. Accordingly, even when the target object 10 is stored in the storage box 80 in which the ejection port is provided in the side surface, it is possible to cause the suction mechanism 600 to approach the suitable position for suction of the target object 10.

Note that after the target object 10 is taken out from the storage box 80 as illustrated in FIG. 14A, the finger unit 21 other than the predetermined finger unit 21 may be caused to function as a retaining finger unit for stabilizing a posture of the target object 10. For example, as illustrated in FIG. 14B, the fingertip (first finger link unit 211) of the finger unit 21 other than the predetermined finger unit 21 may be caused to contact an undersurface of the target object 10. Thereby, the posture of the target object 10 is restrained from being unstable on the way of moving the target object 10 which is picked up to a placement position.

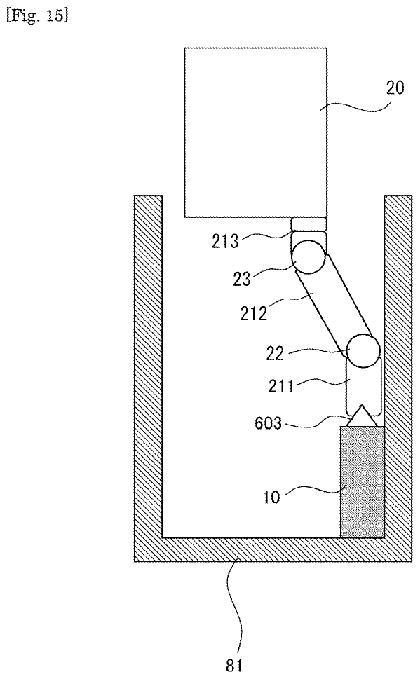

Next, an operation example of the hand mechanism 2 in a case of picking up a target object placed against a wall in a storage box will be described based on FIG. 15. In the example illustrated in FIG. 15, the target object 10 is stored in a state contacting a side wall surface in the storage box 80. In the case like this, the first motor 51, the second motor 52, and the third motor 53 of the predetermined finger unit 21 are controlled first so that the tip end surface of the pad 603 is horizontal, and the predetermined finger unit 21 is in a substantially V-shaped form. Subsequently, the arm mechanism 3 is controlled so that the tip end surface of the pad 603 moves to above the target object 10. After the tip end surface of the pad 603 is moved to above the target object 10, the arm mechanism 3 is controlled so that the hand mechanism 2 lowers along the vertical direction. When control of these is performed, the suction mechanism 600 is moved to a suitable position for suction of the target object 10 (position at which the tip end surface of the pad 603 is in close contact with the top surface of the target object 10) as illustrated in FIG. 15. When the tip end surface of the pad 603 moves to the position at which the tip end surface of the pad 603 is in close contact with the top surface of the target object 10, the negative pressure electromagnetic valve 620 is opened. Thereby, the target object 10 can be suctioned by the suction mechanism 600. Thereafter, the arm mechanism 3 is controlled so that the hand mechanism 2 rises, whereby the target object 10 placed against the wall in the storage box 80 is taken out from the storage box 80. Therefore, even when the target object 10 is placed against the wall in the storage box 80, it is possible to cause the suction mechanism 600 to approach the suitable position for suction of the target object 10. Note that after the target object 10 is taken out from the storage box 80, the finger unit 21 other than the predetermined finger unit 21 may be caused to function as a retaining finger unit for stabilizing the posture of the target object 10 as in FIG. 14B.

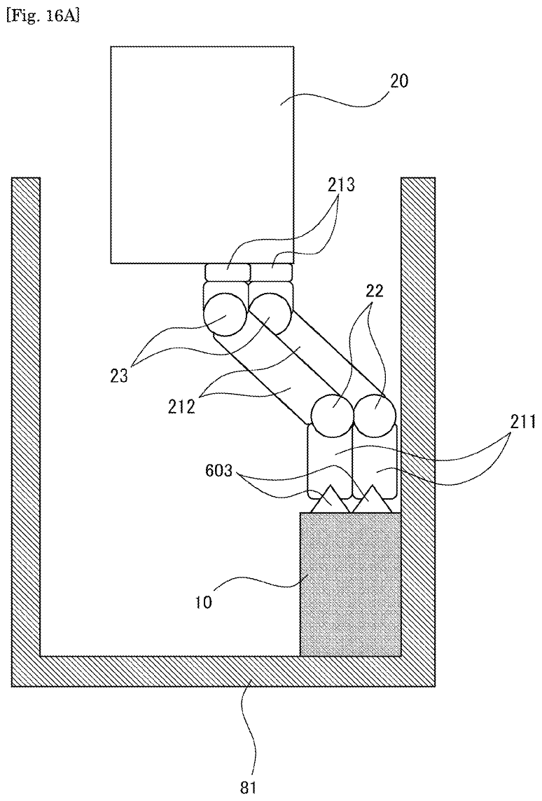

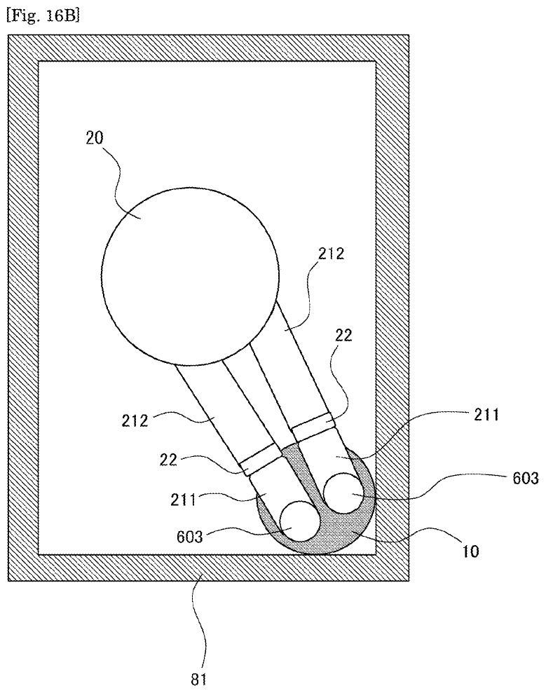

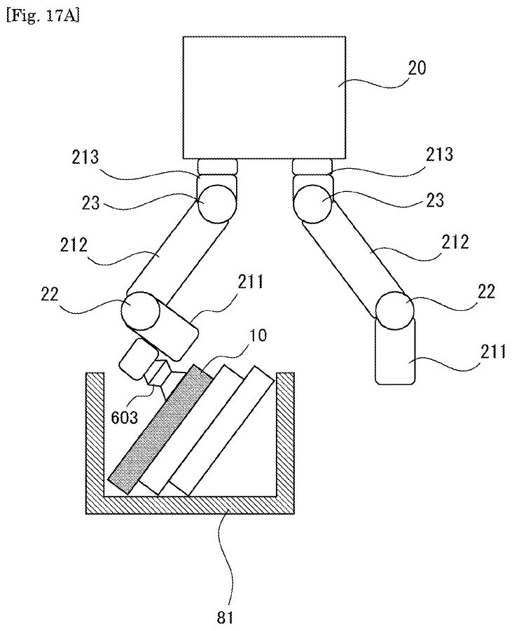

Next, a case of picking up a target object placed at a corner portion in a storage box will be described based on FIG. 16A and FIG. 16B. FIG. 16A is a view of a state of the hand mechanism 2 when picking up the target object 10 viewed from a side. FIG. 16B is a view of the state of the hand mechanism 2 when picking up the target object 10 viewed from above. Note that the target object 10 in FIG. 16A and FIG. 16B is assumed to have a top surface with a relatively wide area. Further, the target object 10 in FIG. 16A and FIG. 16B has a circular section but may have a rectangular section.

In an example illustrated in FIG. 16A and FIG. 16B, the target object 10 is placed at a corner portion in the storage box 80. In a case like this, with respect to each of the two predetermined finger units 21, the first motor 51, the second motor 52, and the third motor 53 of each of the finger units 21 are controlled first so that the tip end surface of the pad 603 is horizontal, and each of the predetermined finger units 21 is in a substantially V-shaped form as in the example illustrated in FIG. 15 described above. Subsequently, the arm mechanism 3 is controlled so that the tip end surfaces of the pads 603 of the two predetermined finger units 21 move to above the target object 10. After the tip end surfaces of the two pads 603 are moved to above the target object 10, the arm mechanism 3 is controlled so that the hand mechanism 2 lowers along the vertical direction. When control of these is performed, the suction mechanisms 600 of the two predetermined finger units 21 are moved to a suitable position for suction of the target object 10 (position at which the tip end surfaces of both the two pads 603 are in close contact with the top surface of the target object 10) as illustrated in FIG. 16A. When both the two pads 603 move to positions at which both of them are in close contact with the top surface of the target object 10, the negative pressure electromagnetic valves 620 are opened. Thereby, the target object 10 can be suctioned by the two suction mechanisms 600 mounted on the two predetermined finger units 21. Thereafter, the arm mechanism 3 is controlled so that the hand mechanism 2 rises, whereby the target object 10 placed at the corner portion of the storage box 80 is taken out from the storage box 80. Therefore, even when the target object 10 is placed at the corner portion in the storage box 80, it is possible to cause the suction mechanisms 600 to approach the suitable positions for suction of the target object 10.

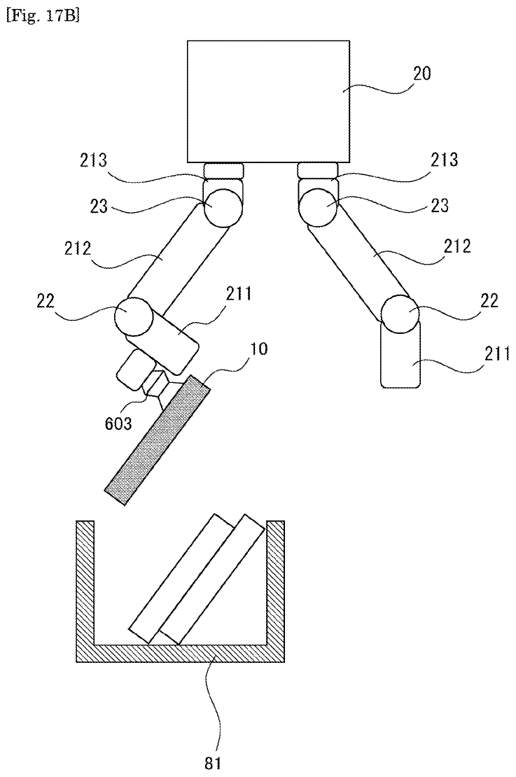

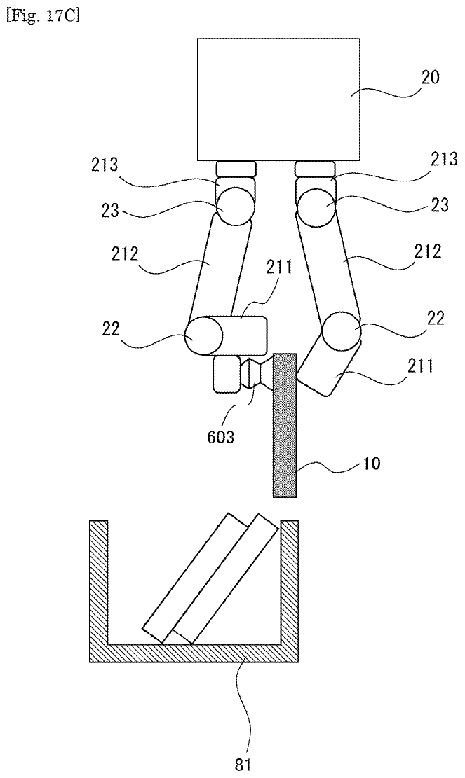

Next, an operation example of the hand mechanism 2 in a case of picking up a target object that is diagonally placed in a storage box will be described based on FIG. 17A to FIG. 17C. FIG. 17A is a view illustrating a state in which the target object 10 is suctioned by the suction mechanism 600. FIG. 17B is a view illustrating a state in which the target object 10 taken out from the storage box is retained by only the suction mechanism 600. FIG. 17C is a view illustrating a state in which the target object 10 taken out from the storage box is retained by the suction mechanism 600 and a retaining finger unit.

In the example illustrated in FIG. 17A, the plate-shaped target object 10 is stored in the storage box 80 in a diagonally tilted state. In the case like this, the arm mechanism 3 and the hand mechanism 2 (the first motor 51, the second motor 52, and the third motor 53 of the predetermined finger unit 21) are controlled first so that in a state where the tip end surface of the pad 603 in the predetermined finger unit 21 is parallel to the top surface of the target object 10, the tip end surface contacts the top surface of the target object 10. When the control like this is performed, the suction mechanism 600 is moved to a suitable position for suction of the target object 10 (position at which the tip end surface of the pad 603 is in close contact with the top surface of the target object 10) as illustrated in FIG. 17A. When the tip end surface of the pad 603 moves to the position at which the tip end surface is in close contact with the top surface of the target object 10, the negative pressure electromagnetic valve 620 is opened. Thereby, the target object 10 can be suctioned by the suction mechanism 600. Thereafter, the arm mechanism 3 is controlled so that the hand mechanism 2 rises, and thereby the target object 10 is taken out from the storage box 80 as illustrated in FIG. 17B. After the target object 10 is taken out from the storage box 80, the hand mechanism 2 is controlled so as to bring the fingertip (first finger link unit 211) of the finger unit 21 other than the predetermined finger unit 21 into contact with a surface on an opposite side from a suction surface of the pad 603 in the target object 10 as illustrated in FIG. 17C. Thereby, it is possible to retain the target object 10 by suction by the suction mechanism 600 and grasp by the finger unit 21 other than the predetermined finger unit 21 and the pad 603. As a result, even when the target object 10 is stored in the storage box 80 in a diagonally tilted state, it is possible to cause the suction mechanism 600 to approach the suitable position for suction of the target object 10, and it is possible to continue to retain the target object 10 taken out from the storage box 80 more reliably.

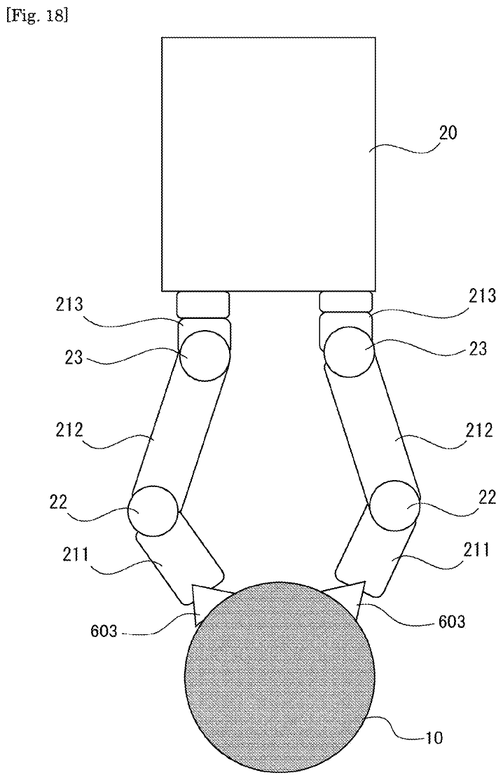

Next, a case of picking up a spherical target object will be described based on FIG. 18. In an example illustrated in FIG. 18, the target object 10 has a spherical shape. In the case like this, in order that each of the two predetermined finger units 21 may be in a substantially V-shaped form, the first motor 51, the second motor 52, and the third motor 53 of each of the finger units 21 are controlled. At this time, the first motor 51, the second motor 52, and the third motor 53 are controlled so that the fingertip (the first finger link unit 211) of one finger unit 21 flexes toward the other finger unit 21, and the fingertip (first finger link unit 211) of the other finger unit 21 flexes toward the one finger unit 21. When the pads 603 of the predetermined finger units 21 are caused to contact the surface of the target object 10 in the state controlled in the form described above, it is possible to bring the two pads 603 into close contact with the surface of the target object 10. Subsequently, when the negative pressure electromagnetic valve 620 of each of the finger units 21 is opened in the state where the two pads 603 are in close contact with the surface of the target object 10, the target object 10 is suctioned by the suction mechanisms 600 of the two predetermined finger units 21. Thereby, it is possible to pick up even the spherical target object 10 in a stable posture.

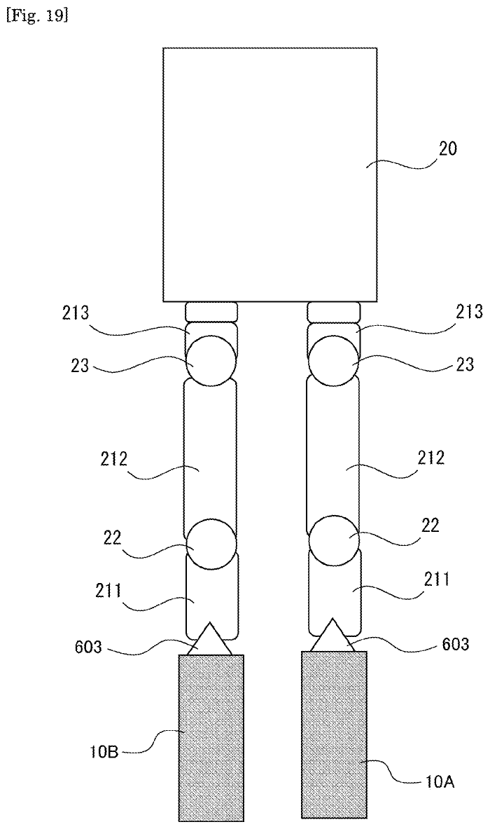

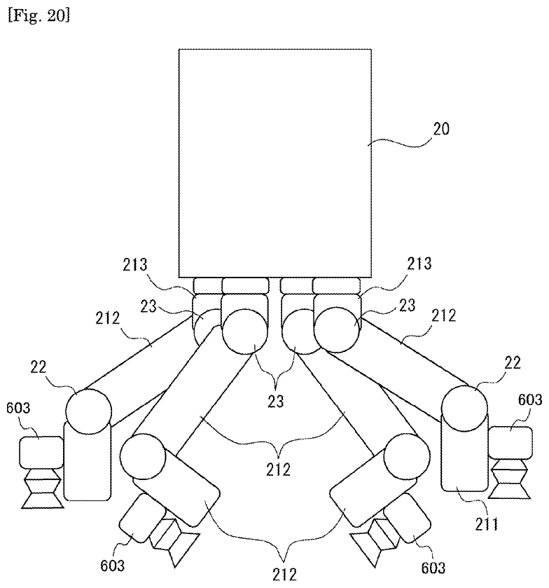

Next, a case of simultaneously picking up two target objects 10 will be described based on FIG. 19. In an example illustrated in FIG. 19, two target objects 10 are placed side by side. In the case like this, the arm mechanism 3 and the hand mechanism 2 are controlled first so that of the two predetermined finger units 21, the pad 603 of one finger unit 21 is positioned above one target object 10, and the pad 603 of the other finger unit 21 is positioned above the other target object 10. Next, the arm mechanism 3 is controlled so that the hand mechanism 2 lowers to a position at which a tip end surface of the one pad 603 is in close contact with a top surface of the one target object 10, and a tip end surface of the other pad 603 is in close contact with a top surface of the other target object 10. When the respective tip end surfaces of the two pads 603 closely contact the top surfaces of the target objects 10 that are objects to be suctioned, the negative pressure electromagnetic valves 620 of the respective finger units 21 are opened. Thereby, the suction mechanisms 600 of the two predetermined finger units 21 can suction the target objects that are different from each other. As a result, it is possible to pick up the two target objects 10 simultaneously.

The various operations described above are realized by the predetermined finger units 21 having two or more degrees of freedom in addition to that the size and the mounting position of the suction mechanism 600 are determined as illustrated in FIG. 10 and FIG. 11 mentioned above.

Consequently, according to the hand mechanism 2 in the present embodiment, grasp of both the target object and suction of the target object can be favorably achieved.

### OTHER EMBODIMENTS

In the embodiment mentioned above, the example in which the suction mechanisms 600 are provided at the two predetermined finger units 21, among the four finger units 21 included by the hand mechanism 2, is described, but as illustrated in FIG. 20, the suction mechanisms 600 may be provided at all the four finger units 21. Thereby, it is possible to enhance the degree of freedom when suctioning the target object. For example, when a target object with a relatively large weight is picked up, it is also possible to pick up the target object 10 by using the suction mechanisms 600 of the three or more finger units 21. At this time, it is also possible to cause the suction mechanisms 600 of some of the finger units 21 of the four finger units 21 to suction the top surface of the target object 10, and cause the suction mechanism 600 of the remaining finger unit 21 to suction a side surface of the target object 10. Further, it is also possible to simultaneously pick up three or more target objects 30. Thereby, it is possible to flexibly change the method for picking up the target object 10 according to various conditions including the examples described above.

Note that in the embodiment mentioned above, the hand mechanism including the four finger units is illustrated, but the number of finger units is not limited to four, and the number of finger units can be properly changed according to the usage conditions or the like of the hand mechanism as long as the number of finger units is two or more. Further, in the embodiment mentioned above, the configuration in which the suction mechanisms are provided at the two finger units among the four finger units is illustrated, but the number of finger units at which the suction mechanisms are provided can be properly changed according to the usage conditions of the hand mechanism, or the like, as long as the number of finger units at which the suction mechanisms are provided is one or more.

### REFERENCE SIGNS LIST

1 Robot arm, 2 Hand mechanism, 20 Base unit, 21 Finger unit, 22 First joint unit, 23 Second joint unit, 211 First finger link unit, 212 Second finger link unit, 213 Base end unit, 215 Ventral surface, 216 Dorsal surface, 3 Arm mechanism, 4 Base seat unit, 51 First motor, 52 Second motor, 53 Third motor, 600 Suction mechanism, 601 Nozzle body, 601A Negative passage, 602 Suction nozzle, 603 Pad, 610 Vacuum pipe, 620 Negative pressure electromagnetic valve

1. A hand mechanism comprising: a plurality of finger units equipped with a first finger link unit including a fingertip, a first joint unit provided at an end portion on a finger base side of the first finger link unit, a second finger link unit connected to the first finger link unit via the first joint unit, and a second joint unit provided at an end portion on a finger base side of the second finger link unit,
wherein the hand mechanism comprising a suction mechanism provided on a dorsal surface of the first finger link unit in at least one predetermined finger unit of the plurality of finger units, and configured to suction and retain a target object by generating negative pressure.

2. The hand mechanism according to claim 1, wherein the suction mechanism comprises
a suction nozzle extending toward a fingertip side from the finger base side of the first finger link unit, and
a pad mounted on a tip end of the suction nozzle and formed to be contractible toward the finger base side from the fingertip side of the first finger link unit,
wherein the suction mechanism is mounted on the first finger link unit so that a position of the tip end of the suction nozzle is positioned on the finger base side from an end portion on the fingertip side of the first finger link unit, in an axial direction of the first finger link unit.

3. The hand mechanism according to claim 2, wherein the suction mechanism is mounted on the first finger link unit so that a position of a tip end surface of the pad in the axial direction of the first finger link unit is at a position protruding in a fingertip direction from the end portion on the fingertip side of the first finger link unit, when the pad is in an uncontracted state.

4. The hand mechanism according to claim 3, wherein the pad is formed so that the position of the tip end surface of the pad in the axial direction of the first finger link unit contracts to a position equivalent to the end portion on the fingertip side of the first finger link unit, when an external force different from an external force at a time of suction of the target object is applied to the pad.

5. The hand mechanism according to claim 1, wherein the hand mechanism is configured to be switchable between a first mode for suctioning and picking up the target object by the suction mechanism of the predetermined finger unit, and a second mode for grasping and picking up the target object by at least two finger units of the plurality of finger units.

6. The hand mechanism according to claim 5, wherein in the first mode, the predetermined finger unit functions as a suction finger unit for bringing the pad in contact with a target object and thereafter suctioning the target object, and at least one finger unit of the finger units other than the predetermined finger unit functions as a retaining finger unit for retaining a posture of the target object suctioned by the predetermined finger unit.
